(19) United States
(12) Patent Application Publication
(10) Pub. No.: US 2009/0014194 A1
(43) Pub. Date: Jan. 15, 2009

(54) Electric power tool

(75) Inventors: Masato Sakai, Ibaraki (JP); Satoru Matsuno, Ibaraki (JP); Masanori Watanabe, Ibaraki (JP); Chikai Yoshimizu, Ibaraki (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: Hitachi Koki Co., Ltd., Hitachinaka-shi (JP)

(21) Appl. No.: 12/230,910

(22) Filed: Sep. 8, 2008

Related U.S. Application Data
(63) Continuation of application No. 11/262,949, filed on Nov. 1, 2005.
Application No. 11/262,949 is a continuation of application No. 10/320,515, filed on Dec. 17, 2002, now Pat. No. 7,108,079.

(30) Foreign Application Priority Data
Feb. 22, 2002 (JP) P2002-046928

(51) Int. Cl. B25D 15/00; B25D 17/00

(52) U.S. Cl. 173/93; 173/217; 173/104

(57) ABSTRACT

A cover which covers outer peripheries of fastening screws are disposed on an outer periphery of a hammer case. A stopper which detachably positions and fixes the cover to the outer periphery of the hammer case is disposed.

The present application is a Continuation Application of U.S. patent application Ser. No. 11/262,949 which was filed on Nov. 1, 2005, which is a Continuation Application of U.S. patent application Ser. No. 10/320,515 which was filed on Dec. 17, 2002, now U.S. Pat. No. 7,108,079.

### BACKGROUND OF THE INVENTION

1. Field of the Invention

The present invention relates to an electric power tool having a hook portion which can be hooked to a waist belt or the like of a worker, such as an impact driver/impact wrench.

2. Description of the Related Art

A conventional electric power tool (impact driver/impact wrench) will be described with reference to FIGS. 13 to 19. FIG. 13 is a side view showing a conventional electric power tool, FIG. 14 is a side view, partly in longitudinal section, showing the conventional electric power tool, FIG. 15 is a side view, partly omitted, of a hook portion of the conventional electric power tool as looking from the right side of FIG. 14, FIG. 16 is a fragmentary section view of the conventional electric power tool as looking from a battery side of FIG. 14, FIG. 17 is a section view of the conventional electric power tool and showing a locked state of a hook as looking from the battery side, FIG. 18 is a section view of the conventional electric power tool and showing an unlocked state of the hook as looking from the battery side, and FIG. 19 is a diagram showing a use state of the conventional electric power tool.

Referring to FIGS. 13 to 18, the electric power tool has an outer frame configured by a two-piece housing 1, a hammer case 2, and so forth, and is formed into an approximately T-like shape. A body portion 1a formed by the housing 1 houses a motor 3 serving as a driving source, a reduction mechanism 4, etc. A handle 1b which hangs from the body portion 1a houses a trigger switch 5, and contacts (not shown) which are to be electrically connected to terminals of a storage battery 6. The hammer case 2 is placed adjacent to the housing 1, and houses: a percussion mechanism 7 which converts the rotative power from the motor 3 into a percussive force; and a holder 8 for a tool bit such as a bit or a wrench which is not shown. According to the configuration, the rotative power from the motor 3 is transmitted to the reduction mechanism 4 from a pinion 3a which is an output shaft of the motor 3, and then to the tool bit from the reduction mechanism 4 via the percussion mechanism 7.

The reduction mechanism 4 is configured by: a stationary-gear support jig 4a which is supported in the housing 1, and which has a rotation stop; a stationary gear 4b; planetary gears 4c; a spindle 9; and needle pins 4d serving as rotation shafts of the planetary gears 4c and supported on the spindle 9. The percussion mechanism 7 is configured by: the spindle 9; a hammer 11 which are made rotatable and movable along the axis of the rotation shaft via steel balls 10 that are inserted into a cam groove 9a formed in the spindle 9; an anvil 12 having anvil claws 12a which are struck by a plurality of hammer claws 11a disposed on the hammer 11 to be rotated; and a spring 13 which always urges the hammer 11 toward the anvil 12.

In the thus configured electric power tool, an impulsive impact which is to be applied to a screw, a nut, or the like that is to be tightened by the tool bit is generated in the following manner. The trigger switch 5 is operated to supply an electric power to the motor 3, thereby rotating the motor 3. Thereafter, the rotative power from the motor 3 is transmitted to the planetary gears 4c via the pinion 3a which is coupled to the front end of the motor 3, and the rotative power from the pinion 3a is transmitted to the spindle 9 via the needle pins 4d by means of meshing between the planetary gears 4c and the stationary gear 4b. The turning force of the spindle 9 is transmitted to the hammer 11 via the steel balls 10 which are arranged between the cam groove 9a of the spindle 9 and a cam groove 11b of the hammer 11. The hammer claws 11a of the hammer 11 which is urged to the front side (toward the bit) by the spring 13 placed between the hammer 11 and the planetary gears 4c of the spindle 9 are caused to strike the anvil claws 12a of the anvil 12 by the rotation, so that the impact is generated. When the striking energy of the hammer 11 is reduced after the striking and the torque of the anvil 12 is reduced, the hammer 11 is repelled from the anvil 12, and hence the hammer 11 moves (retracts) along the cam groove toward the planetary gears 4c. Thereafter, the hammer 11 is pushed back toward the anvil 12 along the cam groove by the compressive force of the spring 13, and the hammer claws 11a again strike the anvil claws 12a by the rotation of the spindle 9. In this way, a continuous impact torque is applied to the tool bit such as a bit or a wrench by repeatedly conducting the striking against the anvil claws 12a by the axial movement and rotation of the hammer 11, so that a work of fastening a screw or a nut onto a work member 14, or that of loosening a screw or a nut from the work member 14 can be conducted.

An elastomer 15 is applied by two-layer molding to the surface of the housing 1 of the electric power tool having the percussion mechanism 7 and the reduction mechanism 4 which have been described above, specifically, on the rear face of the body portion 1a of the housing 1 and the handle 1b. The purposes of application of the elastomer 15 are to improve an antislipping function of surely gripping the electric power tool or a grip feeling, thereby enhancing the operability and the workability, to absorb an impact when the electric power tool is dropped on the ground, thereby preventing the tool from being damaged, and to, when the electric power tool is placed on an inclined face, prevent the tool from slipping down along the inclination. In order to enhance the effects of preventing the electric power tool from being damaged and of antislipping, the elastomer 15 may be applied to the periphery of a battery holder 1c.

As shown in FIGS. 13 to 18, in order to enable the body of the electric power tool to be hooked to a waist belt or the like of a worker, the electric power tool is provided with a rotatable hook-portion 19 configured by an engagement member 16, a holding portion 17, and a strap portion 18 which will be described below.

The hook portion 19 comprises: the engagement member 16 which can house a tool bit 20 such as a bit, and which has a substantially cylindrical basal end 16a made of a resin; the holding portion 17 which has a through hole 17a that can house the basal end 16a of the engagement member 16, and which extends from the handle 1b to a position adjacent to a side face of the storage battery 6; a bolt 21 serving as a fixing member which is passed through the holding portion 17, and which is screwed with a nut 16b serving as a locking member disposed in the basal end 16a, to prevent the engagement member 16 from slipping off from the holding portion 17; and an elastic member 22 formed by a spring or elastic rubber which urges the engagement member 16 in a direction along which the engagement member is locked to a nonrotatable position. In the basal end 16a of the engagement member 16 having a substantially L-like shape, disposed are: a cylindrical rotation tube 16c which uses a pivotal axis 23 as a rotation axis; an angle adjusting gear 16d which is formed on the rotation tube 16c, which protrudes in the direction of the pivotal axis 23, and which has a plurality of teeth that project radially outward with respect to the pivotal axis 23; a first ring portion 16e which protrudes so as to have a diameter that is substantially equal to the inner diameter of the angle adjusting gear 16d; and a second ring portion 16f having a diameter that is equal to or smaller than the outer diameter of the first ring portion 16e. In the basal end 16a, a nut housing portion 16g which has a half-hexagonal wall shape, and which nonrotatably houses the nut 16b that is to be screwed with the bolt 21 passed into the basal end from the side of the second ring portion 16f is disposed, and the through hole (bolt hole) 17a for housing the bolt 21 is disposed in the direction of the pivotal axis 23 in the range from the nut housing portion 16g to the second ring portion 16f. A step portion 16i for forming an outer diameter which is larger than the outer diameter of the rotation tube 16c is disposed on the end face of the rotation tube 16c which is positioned on the side opposite to the angle adjusting gear 16d, i.e., a rising protruding portion of the rotation tube 16c in the engagement member 16 having an antislipping portion 16h. A rotation inhibiting plate 16j which restricts the turning range of the engagement member 16 protrudes from the outer periphery of the rotation tube 16c.

On the other hand, the holding portion 17 is symmetrical about the split plane of the housing 1, and has the through hole (cylindrical hole) 17a in which the basal end 16a is to be housed. The through hole 17a is configured by: a rotation support hole 17b which houses the rotation tube 16c; a ring gear 17c which has a plurality of teeth, and which can mesh with the angle adjusting gear 16d; and a receiving hole 17d which houses a hooking spring 22 disposed between the ring gear 17c and the bolt 21 having a slotted head (bolt head) 21a, and the bolt head 21a. A rotation inhibiting plate receiving groove 17e which abuts against the rotation inhibiting plate 16j in order to restrict the turning range of the engagement member 16 to a predetermined angle range is formed in the rotation support hole 17b.

The strap portion 18 is disposed above the holding portion 17 and configured by: a strap screw 18a which is in parallel to the axial length of the basal end 16a that is passed through the through hole 17a; a through hole 18b through which the strap screw 18a is to be passed; and a strap nut 18c which is to be screwed with the strap screw 18a so as to prevent the strap screw 18a from slipping off from the through hole 18b. A cutaway portion 18d through which the strap screw 18a is exposed is formed in a part of the strap portion 18. A ring portion 18f which is formed in one end of a strap 18e is passed through the cutaway portion 18d. Thereafter, the strap screw 18a is passed into the ring portion 18f and then screwed with the strap nut 18c, thereby enabling the strap 18e to be hooked on the shaft of the strap screw 18a. Since the strap portion 18 is disposed above the holding portion 17 as described above, the engagement member 16 which is detachably disposed on the holding portion 17 is placed adjacent to a side wall of the storage battery 6.

Next, the methods of attaching and detaching the engagement member 16 to and from the holding portion 17 of the housing 1 will be described. In the state where the nut 16b is inserted into the nut housing portion 16g, first, the engagement member 16 is passed through the through hole 17a of the holding portion 17, the hooking spring 22 is passed into the receiving hole 17d along the second ring portion 16f, and a thread portion 21b disposed on the front end of the bolt 21 is screwed with a thread portion 16k formed inside the nut 16b, whereby the engagement member 16 can be attached to the holding portion 17 via the hooking spring 22. The engagement member 16 can be easily detached from the holding portion 17 of the housing 1 by conducting the above-mentioned procedure in the reverse sequence. As described above, the holding portion 17 is symmetrical about the split plane of the housing 1, and the engagement member 16 which can house the tool bit 20 such as a bit has a substantially linear shape. In accordance with, for example, the handedness of the worker, therefore, the engagement member 16 can be inserted into and attached to either of the right and left sides of the holding portion 17, to be used without causing any difficulty.

Next, an operation of turning the engagement member 16 will be described with reference to FIGS. 13 to 18. FIGS. 13 to 18 show a state where the engagement member 16 is positioned and fixed in a position adjacent to the side face of the storage battery 6. The engagement member 16 is configured so that the pressure of the hooking spring 22 is applied in the direction of pushing out the bolt head 21a with using a spring receiving end face 161 in the holding portion as a fulcrum, and the step portion 16i is supported with abutting against an end face 17f of the holding portion 17, whereby the member is prevented from being separated, and also that the angle adjusting gear 16d is held in the meshing state with the ring gear 17c, and hence the pivotal axis 23 of the basal end 16a is prevented from being rotated in the circumferential direction, whereby stabilized positioning and fixation can be attained. The position where the engagement member 16 is positioned adjacent to the vicinity of the side face of the storage battery 6 is one of positions where the end face of the rotation inhibiting plate 16j abuts against that of the rotation inhibiting plate receiving groove 17e. Therefore, the engagement member 16 can be turned to the position.

In this state, the engagement member 16 is turned in the following manner. As shown in FIGS. 13 to 18, when the antislipping portion 16h of the engagement member 16 is nipped by the fingers and then pulled in the direction of the pivotal axis 23 (the upward direction in the figure), the meshing between the angle adjusting gear 16d of the basal end 16a and the ring gear 17c is cancelled. Therefore, the engagement member 16 can be turned within the predetermined angle range. When the engagement member 16 is released at an arbitrary position, the angle adjusting gear 16d and the ring gear 17c are caused to mesh with each other by the elastic force of the hooking spring 22, and the engagement member can be positioned and fixed.

As described above, the hammer case which houses the percussion mechanism for converting the rotational power from the motor 3 into a percussive force, the holder for a tool bit such as a bit or a wrench that is not shown, and the like constitutes together with the housing the appearance of the electric power tool as shown in FIGS. 13 to 19. The hammer case abuts against the housing and is attached thereto by fastening screws. The heads of the fastening screws are exposed in the same manner as the hammer case. In the case where a work of fastening a screw is conducted in a corner as shown in FIG. 19, therefore, the heads of the fastening screws are in contact with the work member, thereby causing a problem in that the work member is damaged. Since the heads of the fastening screws are exposed in a projecting state, the heads are in contact with another member when the electric power tool is carried, thereby causing another problem in that the member is similarly damaged.

Depending on the kind of a work, the user sometimes conducts the work while gripping the outer periphery of the hammer case. In such a case, when the hammer case is heated by the heat which is generated during a process of striking the anvil claws by the hammer claws, it is difficult to grip the hammer case, thereby causing a further problem in that the workability and the operability are lowered.

In the case where a hammer case made of aluminum is gripped, when the hands of the user are wet with perspiration or water, slippage easily occurs to cause a further problem in that a work cannot be stably conducted.

Since coating is applied to the hammer case in order to prevent corrosion from occurring and improve the appearance, there is a further problem in that the coating work increases the cost and requires much labor.

### SUMMARY OF THE INVENTION

It is an object of the invention to provide an electric power tool which can solve the problems, which can prevent a work member from being damaged, which is excellent in workability and operability, and which is economical.

The object can be accomplished by an electric power tool comprising: a motor serving as a driving source; a reduction mechanism which transmits rotative power from the motor; a percussion mechanism which converts the rotative power from the reduction mechanism into a percussive force; a hammer case which houses the percussion mechanism, the hammer case being made of metal; a housing which is adjacent to the hammer case, and which houses the motor; and fastening screws for disposing the hammer case on the housing, wherein a cover which covers outer peripheries of the fastening screws is disposed on an outer periphery of the hammer case.

### BRIEF DESCRIPTION OF THE DRAWINGS

FIG. 1 is a side view showing the electric power tool of the invention.

FIG. 2 is a side view, partly in longitudinal section, showing the electric power tool of the invention.

FIG. 3 is a section view showing a locked state of a hook as looking the electric power tool of the invention from the side of a storage battery.

FIG. 4 is a section view showing an unlocked state of the hook as looking the electric power tool of the invention from the side of the storage battery.

FIG. 5 is an external perspective view showing a cover which is disposed in the vicinity of a hammer case of the electric power tool of the invention.

FIG. 6 is an external perspective view showing a stopper which positions and fixes the cover disposed on the electric power tool of the invention.

FIG. 7 is an external perspective view showing the inner side of the stopper shown in FIG. 6.

FIG. 8 is an enlarged longitudinal sectional side view of main portions and showing a state where the cover is disposed on the electric power tool of the invention and the cover is positioned and fixed by the stopper.

FIG. 9 is a diagram showing a use state of the electric power tool of the invention.

FIG. 10 is a diagram showing another use state of the electric power tool of the invention.

FIGS. 11A and 11B are a front view and a plan view showing a state where another cover according to the invention is attached to an electric power tool.

FIGS. 12A and 12B are a front view and a plan view showing a state where a further cover according to the invention is attached to an electric power tool.

FIG. 13 is a side view showing a conventional electric power tool.

FIG. 14 is a side view, partly in longitudinal section, showing the conventional electric power tool.

FIG. 15 is a side view, partly omitted, of a hook portion of the conventional electric power tool as looking from the right side of FIG. 14.

FIG. 16 is a fragmentary section view of the conventional electric power tool as looking from the battery side of FIG. 14.

FIG. 17 is a section view showing a locked state of a hook as looking the conventional electric power tool from the battery side.

FIG. 18 is a section view showing an unlocked state of the hook as looking the conventional electric power tool from the battery side.

FIG. 19 is a diagram showing another use state of the conventional electric power tool.

### DETAILED DESCRIPTION OF THE PREFERRED EMBODIMENTS

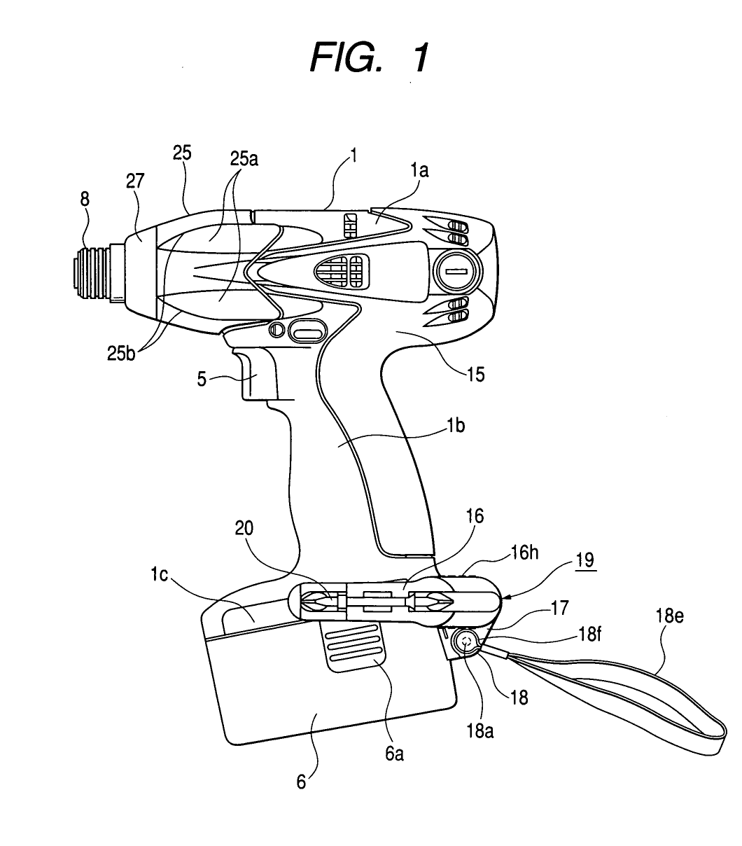

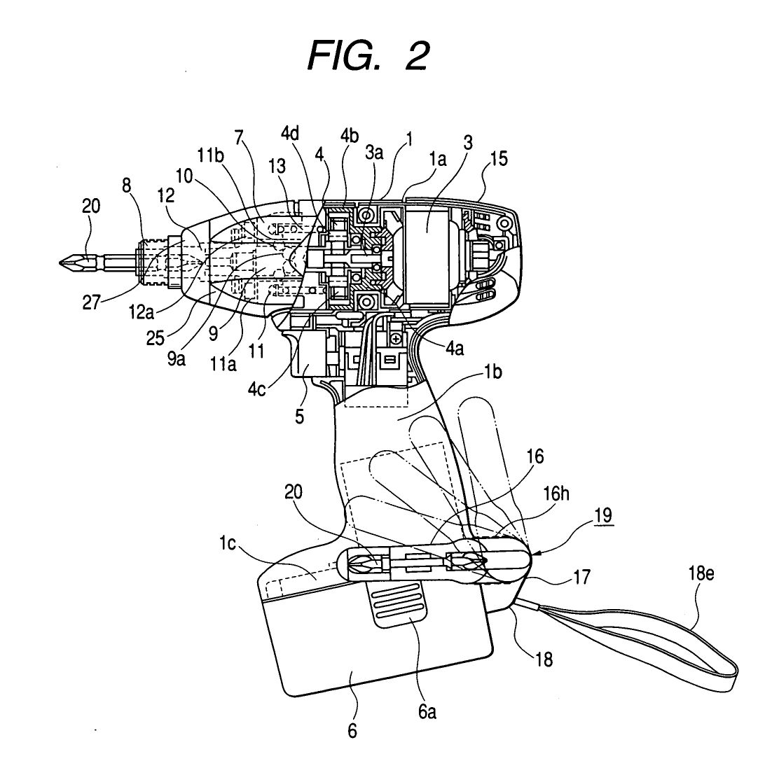

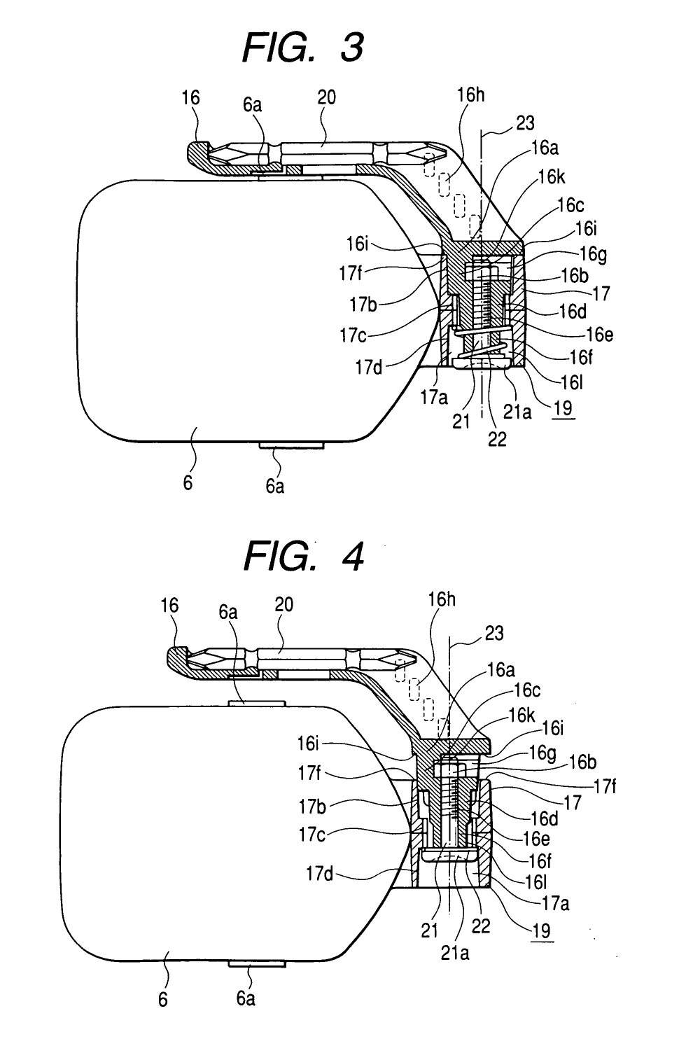

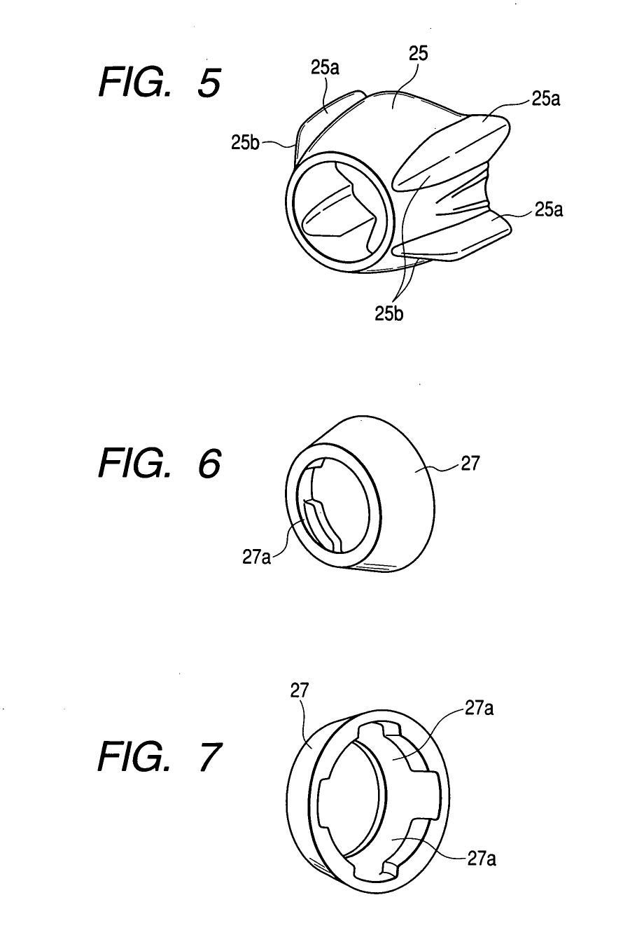

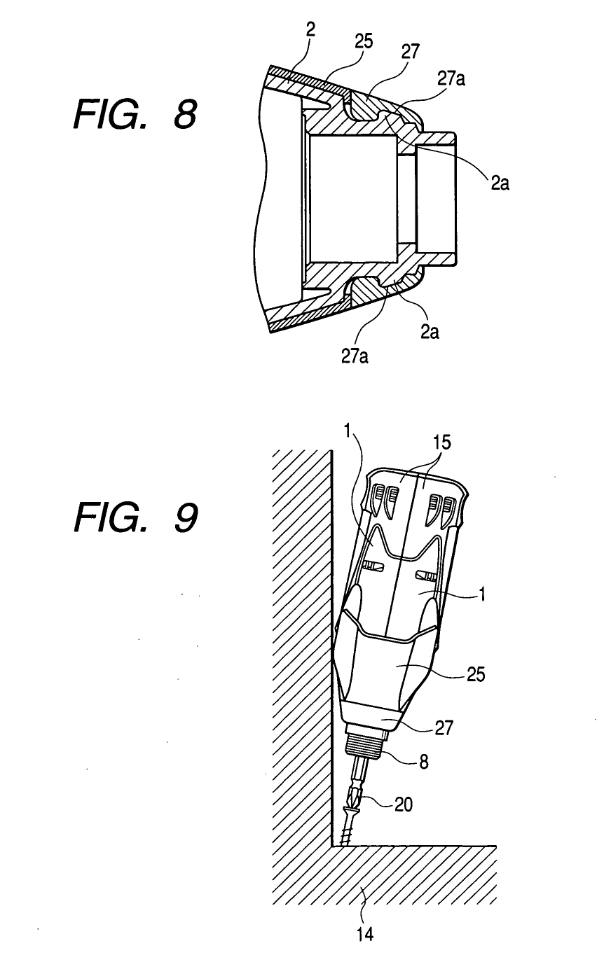

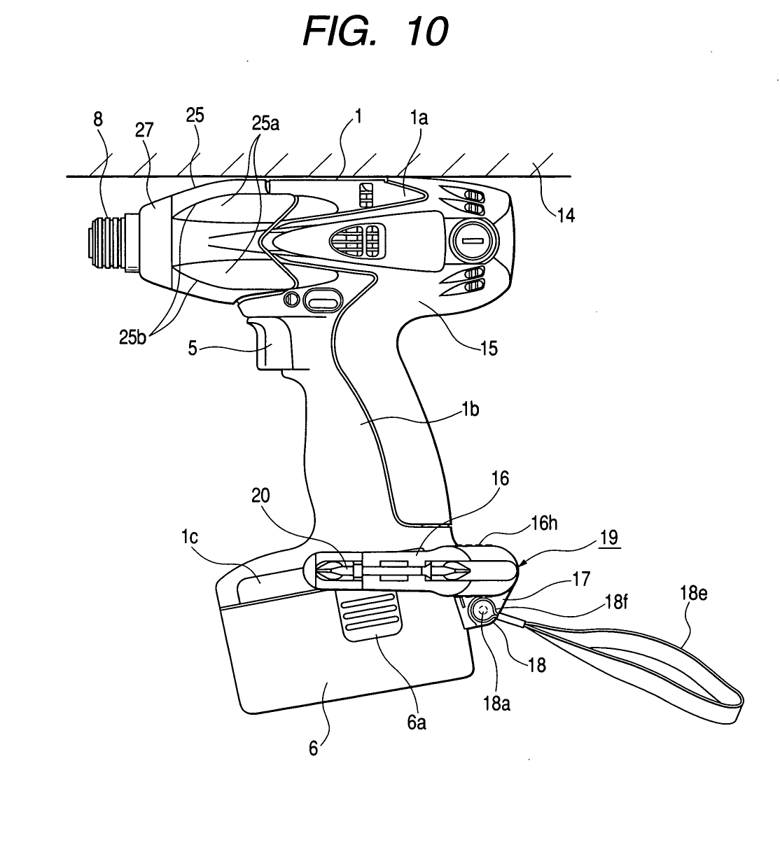

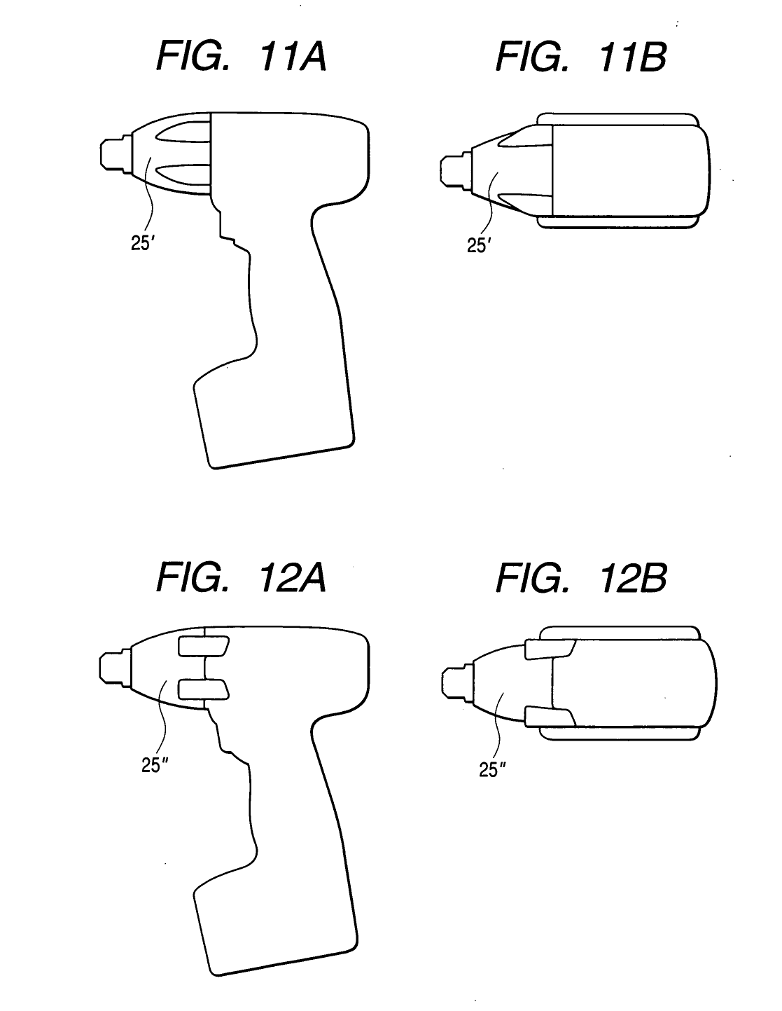

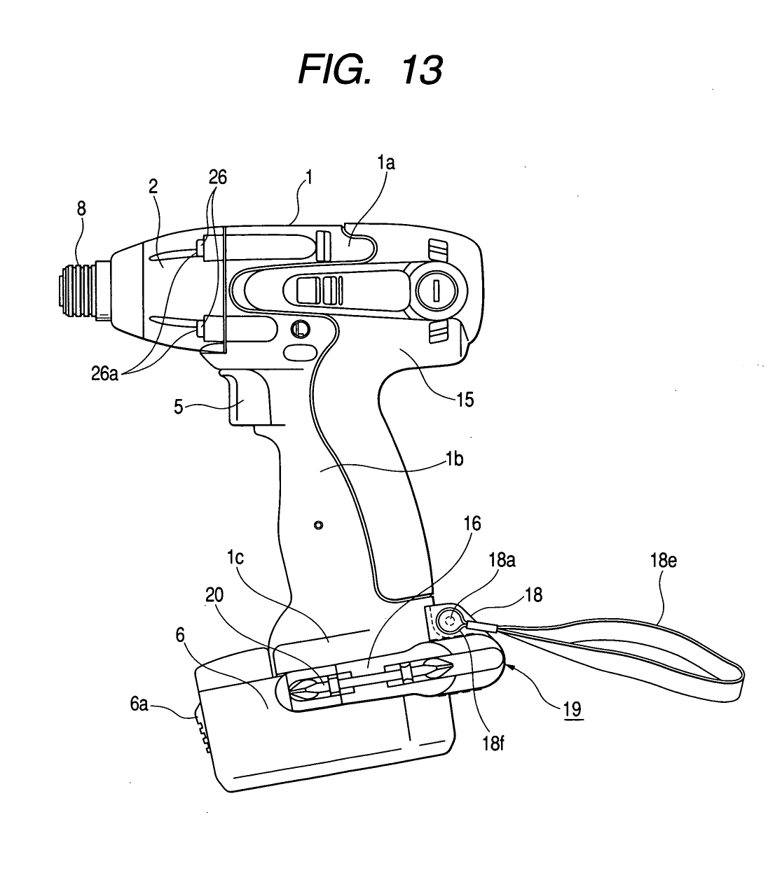

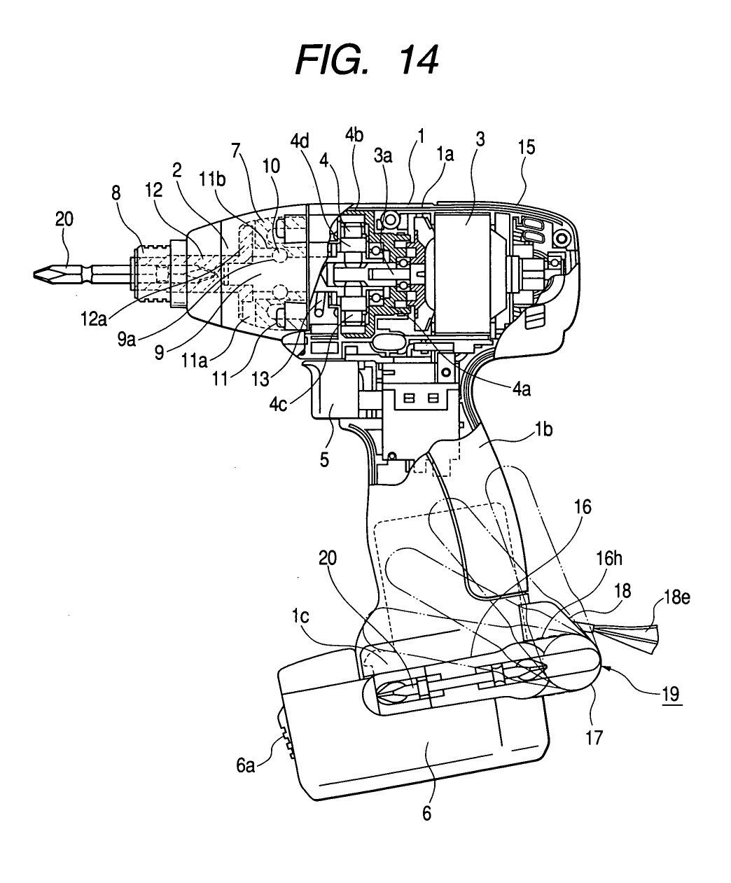

Hereinafter, an electric power tool (impact driver/impact wrench) of an embodiment will be described with reference to FIGS. 1 to 12. FIG. 1 is a side view showing the electric power tool of the embodiment, FIG. 2 is a side view, partly in longitudinal section, showing the electric power tool of the embodiment, FIG. 3 is a section view showing a locked state of an engagement member 16 as looking the electric power tool of the embodiment from the side of a storage battery 6, FIG. 4 is a section view showing an unlocked state of the engagement member 16 as looking the electric power tool of the embodiment from the side of the storage battery, FIG. 5 is an external perspective view showing a cover 25 which is disposed in the vicinity of a hammer case 2 of the electric power tool of the embodiment, FIG. 6 is an external perspective view showing a stopper 27 which positions and fixes the cover 25 disposed on the electric power tool, FIG. 7 is an external perspective view showing the inner side of the stopper 27 shown in FIG. 6, FIG. 8 is an enlarged longitudinal sectional side view of main portions and showing a state where the cover 25 is disposed on the electric power tool of the embodiment and the cover 25 is positioned and fixed by the stopper 27, FIG. 9 is a diagram showing a use state of the electric power tool of the embodiment, FIG. 10 is a diagram showing another use state of the electric power tool of the embodiment, FIG. 11 is an external perspective view showing another cover 25′ in the embodiment, and FIG. 12 is an external perspective view showing a further cover 25″ in the embodiment.

Referring to FIGS. 1 and 2, the electric power tool has an outer frame configured by a two-piece housing 1, the hammer case 2, and so forth, and is formed into an approximately T-like shape. A body portion 1a formed by the housing 1 houses a motor 3 serving as a driving source, a reduction mechanism 4, etc. A handle 1b which hangs from the body portion 1a houses a trigger switch 5, and contacts (not shown) which are to be electrically connected to terminals of a storage battery 6. The hammer case 2 is placed adjacent to the housing 1, and houses: a percussion mechanism 7 which converts the rotative power from the motor 3 into a percussive force; and a holder 8 for a tool bit such as a bit or a wrench which is not shown. According to the configuration, the rotative power from the motor 3 is transmitted to the reduction mechanism 4 from a pinion 3a which is an output shaft of the motor 3, and then to the tool bit from the reduction mechanism 4 via the percussion mechanism 7.

The reduction mechanism 4 is configured by: a stationary-gear support jig 4a which is supported in the housing 1, and which has a rotation stop; a stationary gear 4b; planetary gears 4c; a spindle 9; and needle pins 4d serving as rotation shafts of the planetary gears 4c and supported on the spindle 9. The percussion mechanism 7 is configured by: the spindle 9; a hammer 11 which are made rotatable and movable along the axis of the rotation shaft via steel balls 10 that are inserted into a cam groove 9a formed in the spindle 9; an anvil 12 having anvil claws 12a which are struck by a plurality of hammer claws 11a disposed on the hammer 11 to be rotated; and a spring 13 which always urges the hammer 11 toward the anvil 12.

In the thus configured electric power tool, an impulsive impact which is to be applied to a screw, a nut, or the like that is to be tightened by the tool bit is generated in the following manner. The trigger switch 5 is operated to supply an electric power to the motor 3, thereby rotating the motor 3. Thereafter, the rotative power from the motor 3 is transmitted to the planetary gears 4c via the pinion 3a which is coupled to the front end of the motor 3, and the rotative power from the pinion 3a is transmitted to the spindle 9 via the needle pins 4d by means of meshing between the planetary gears 4c and the stationary gear 4b. The turning force of the spindle 9 is transmitted to the hammer 11 via the steel balls 10 which are arranged between the cam groove 9a of the spindle 9 and a cam groove 11b of the hammer 11. The hammer claws 11a of the hammer 11 which is urged to the front side (toward the bit) by the spring 13 placed between the hammer 11 and the planetary gears 4c of the spindle 9 are caused to strike the anvil claws 12a of the anvil 12 by the rotation, so that the impact is generated. When the striking energy of the hammer 11 is reduced after the striking and the torque of the anvil 12 is reduced, the hammer 11 is repelled from the anvil 12, and hence the hammer 11 moves (retracts) along the cam groove toward the planetary gears 4c. Thereafter, the hammer 11 is pushed back toward the anvil 12 along the cam groove by the compressive force of the spring 13, and the hammer claws 11a again strike the anvil claws 12a by the rotation of the spindle 9. In this way, a continuous impact torque is applied to the tool bit such as a bit or a wrench by repeatedly conducting the striking against the anvil claws 12a by the axial movement and rotation of the hammer 11, so that a work of fastening a screw or a nut onto a work member 14, or that of loosening a screw or a nut from the work member 14 can be conducted.

An elastomer 15 is applied by two-layer molding to the surface of the housing 1 of the electric power tool having the percussion mechanism 7 and the reduction mechanism 4 which have been described above, specifically, on the rear face of the body portion 1a of the housing 1 and the handle 1b. The purposes of application of the elastomer 15 are to improve an antislipping function of surely gripping the electric power tool or a grip feeling, thereby enhancing the operability and the workability, to absorb an impact when the electric power tool is dropped on the ground, thereby preventing the tool from being damaged, and to, when the electric power tool is placed on an inclined face, prevent the tool from slipping down along the inclination. In order to enhance the effects of preventing the electric power tool from being damaged and of antislipping, the elastomer 15 may be applied to the periphery of a battery holder 1c.

As shown in FIGS. 1 to 4, in order to enable the body of the electric power tool to be hooked to a waist belt or the like of a worker, the electric power tool is provided with a rotatable hook portion 19 configured by an engagement member 16, a holding portion 17, and a strap portion 18 which will be described below.

The hook portion 19 comprises: the engagement member 16 which can house a tool bit 20 such as a bit, and which has a substantially cylindrical basal end 16a made of a resin; the holding portion 17 which has a through hole 17a that can house the basal end 16a of the engagement member 16, and which extends from the handle 1b to a position adjacent to a side face of the storage battery 6; a bolt 21 serving as a fixing member which is passed through the holding portion 17, and which is screwed with a nut 16b serving as a locking member disposed in the basal end 16a, to prevent the engagement member 16 from slipping off from the holding portion 17; and an elastic member 22 formed by a spring or elastic rubber which urges the engagement member 16 in a direction along which the engagement member is locked to a nonrotatable position. In the basal end 16a of the engagement member 16 having a substantially L-like shape, disposed are: a cylindrical rotation tube 16c which uses a pivotal axis 23 as a rotation axis; an angle adjusting gear 16d which is formed on the rotation tube 16c, which protrudes in the direction of the pivotal axis 23, and which has a plurality of teeth that project radially outward with respect to the pivotal axis 23; a first ring portion 16e which protrudes so as to have a diameter that is substantially equal to the inner diameter of the angle adjusting gear 16d; and a second ring portion 16f having a diameter that is equal to or smaller than the outer diameter of the first ring portion 16e. In the basal end 16a, a nut housing portion 16g which has a half-hexagonal wall shape, and which nonrotatably houses the nut 16b that is to be screwed with the bolt 21 passed into the basal end from the side of the second ring portion 16f is disposed, and the through hole (bolt hole) 17a for housing the bolt 21 is disposed in the direction of the pivotal axis 23 in the range from the nut housing portion 16g to the second ring portion 16f. A step portion 16i for forming an outer diameter which is larger than the outer diameter of the rotation tube 16c is disposed on the end face of the rotation tube 16c which is positioned on the side opposite to the angle adjusting gear 16d, i.e., a rising protruding portion of the rotation tube 16c in the engagement member 16 having an antislipping portion 16h. A rotation inhibiting plate 16j which restricts the turning range of the engagement member 16 protrudes from the outer periphery of the rotation tube 16c.

On the other hand, the holding portion 17 is symmetrical about the split plane of the housing 1, and has the through hole (cylindrical hole) 17a in which the basal end 16a is to be housed. The through hole 17a is configured by: a rotation support hole 17b which houses the rotation tube 16c; a ring gear 17c which has a plurality of teeth, and which can mesh with the angle adjusting gear 16d; and a receiving hole 17d which houses a hooking spring 22 disposed between the ring gear 17c and the bolt 21 having a slotted head (bolt head) 21a, and the bolt head 21a. A rotation inhibiting plate receiving groove 17e which abuts against the rotation inhibiting plate 16j in order to restrict the turning range of the engagement member 16 to a predetermined angle range is formed in the rotation support hole 17b.

The strap portion 18 is disposed below the holding portion 17 and configured by: a strap screw 18a which is in parallel to the axial length of the basal end 16a that is passed through the through hole 17a; a through hole 18b through which the strap screw 18a is to be passed; and a strap nut 18c which is to be screwed with the strap screw 18a so as to prevent the strap screw 18a from slipping off from the through hole 18b. A cutaway portion 18d through which the strap screw 18a is exposed is formed in a part of the strap portion 18. A ring portion 18f which is formed in one end of a strap 18e is passed through the cutaway portion 18d. Thereafter, the strap screw 18a is passed into the ring portion 18f and then screwed with the strap nut 18c, thereby enabling the strap 18e to be hooked on the shaft of the strap screw 18a. Since the strap portion 18 is disposed below the holding portion 17 as described above, the engagement member 16 which is detachably disposed on the holding portion 17 is placed adjacent to a cover portion (skirt portion) 1c which houses a part of the storage battery 6. During a process of operating an operating portion (latch) 6a of the storage battery in which an attaching or detaching work is conducted on the handle 1b, therefore, the engagement member 16 does not obstruct the operation, and hence the user can easily attach or detach the storage battery 6.

Next, the methods of attaching and detaching the engagement member 16 to and from the holding portion 17 of the housing 1 will be described. In the state where the nut 16b is inserted into the nut housing portion 16g, first, the engagement member 16 is passed through the through hole 17a of the holding portion 17, the hooking spring 22 is passed into the receiving hole 17d along the second ring portion 16f, and a thread portion 21b disposed on the front end of the bolt 21 is screwed with a thread portion 16k formed inside the nut 16b, whereby the engagement member 16 can be attached to the holding portion 17 via the hooking spring 22. The engagement member 16 can be easily detached from the holding portion 17 of the housing 1 by conducting the above-mentioned procedure in the reverse sequence. As described above, the holding portion 17 is symmetrical about the split plane of the housing 1, and the engagement member 16 which can house the tool bit 20 such as a bit has a substantially linear shape. In accordance with, for example, the handedness of the worker, therefore, the engagement member 16 can be inserted into and attached to either of the right and left sides of the holding portion 17. Even when the engagement member 16 is attached to either of the sides, the engagement member can be placed adjacent to the vicinity of the cover portion 1c which houses a part of the storage battery 6. Therefore, the engagement member 16 is placed in a position where, during a process of operating the operating portion 6a of the storage battery 6 in which an attaching or detaching work is conducted on the handle 1b, the engagement member 16 does not obstruct the operation, and hence the user can easily attach or detach the storage battery 6, so that the workability and the operability can be improved.

As described above, the embodiment has a shape in which the engagement member 16 can be attached to either of the right and left sides of the holding portion 17 without causing any difficulty. In order to prevent the engagement member 16 from obstructing an operation on the operating portion 6a of the storage battery 6, the engagement member 16 may have a bent shape in place of the substantially linear shape. In this configuration, in the cases where the engagement member 16 is inserted from the left side of the holding portion 17, and where the engagement member 16 is inserted from the right side of the holding portion 17, the vertical relationship of the engagement member 16 is inverted. Therefore, there arises a case where the engagement member 16 is positioned above the operating portion 6a of the storage battery 6. When the engagement member 16 is to be replaced with another one as required, therefore, it is necessary to separately prepare dedicated engagement members such as an engagement member for the left side, and that for the right side. This impairs the ease of use, and increases the economic burden on the user.

Next, an operation of turning the engagement member 16 will be described with reference to FIGS. 2 to 4. FIGS. 2 and 3 show a state where the engagement member 16 is positioned and fixed in a position adjacent to the cover portion (skirt portion) 1c which houses a part of the storage battery 6. The engagement member 16 is configured so that the pressure of the hooking spring 22 is applied in the direction of pushing out the bolt head 21a with using a spring receiving end face 161 in the holding portion as a fulcrum, and the step portion 16i is supported with abutting against an end face 17f of the holding portion 17, whereby the member is prevented from being separated, and also that the angle adjusting gear 16d is held in the meshing state with the ring gear 17c, and hence the pivotal axis 23 of the basal end 16a is prevented from being rotated in the circumferential direction, whereby stabilized positioning and fixation can be attained. In the embodiment, the position where the engagement member 16 is positioned adjacent to the vicinity of the cover portion 1c housing a part of the storage battery 6 is one of positions where the end face of the rotation inhibiting plate 16j abuts against that of the rotation inhibiting plate receiving groove 17e. Therefore, the engagement member 16 can be turned to the position.

In this state, the engagement member 16 is turned in the following manner. As shown in FIGS. 2 and 4, when the antislipping portion 16h of the engagement member 16 is nipped by the fingers and then pulled in the direction of the pivotal axis 23 (the upward direction in the figure), the meshing between the angle adjusting gear 16d of the basal end 16a and the ring gear 17c is cancelled. Therefore, the engagement member 16 can be turned within the predetermined angle range. When the engagement member 16 is released at an arbitrary position, the angle adjusting gear 16d and the ring gear 17c are caused to mesh with each other by the elastic force of the hooking spring 22, and the engagement member can be positioned and fixed.

The engagement member 16 in the embodiment attains an effect that positioning and fixation can be conducted in an arbitrary position by the simple configuration and method, and has great versatility to be used in a wide variety of portable tools, in addition to an exemplified impact driver/impact wrench, such as a circular saw, a drill, a disk grinder, a driver, a hammer, a hammer drill, a jigsaw, a cutter, a saber saw, an air tool, and a nailing machine.

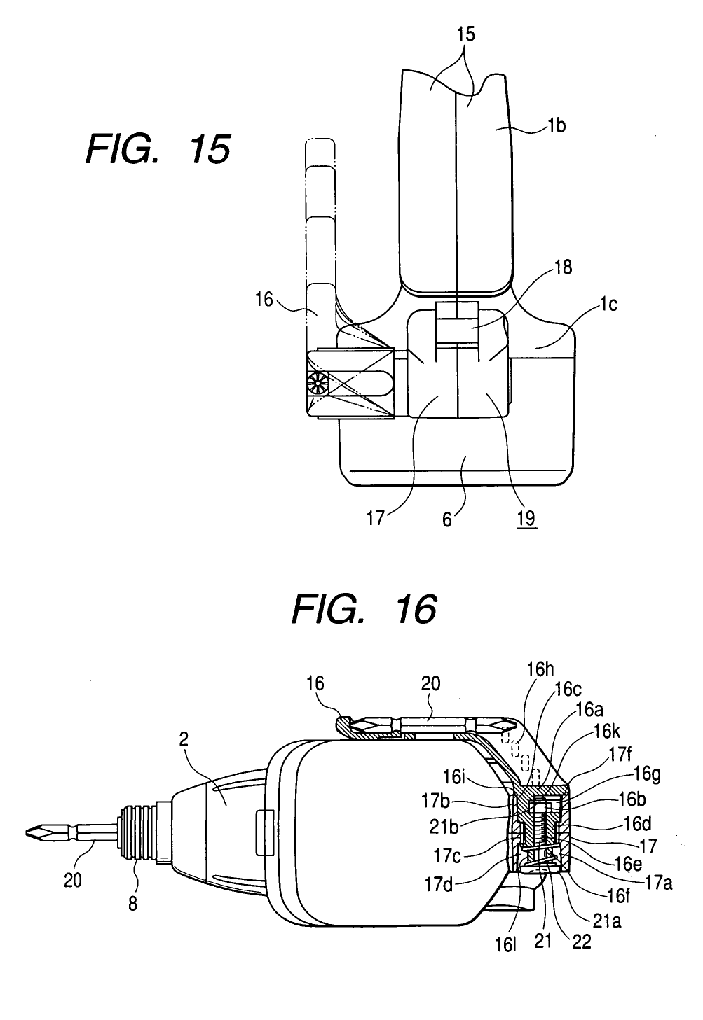

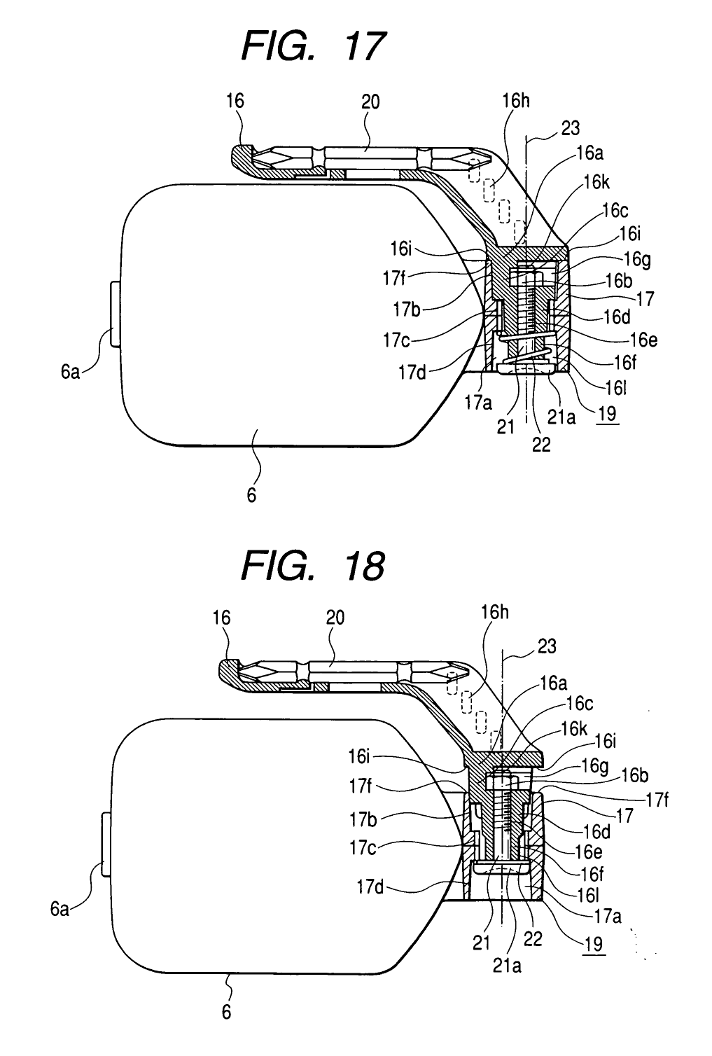

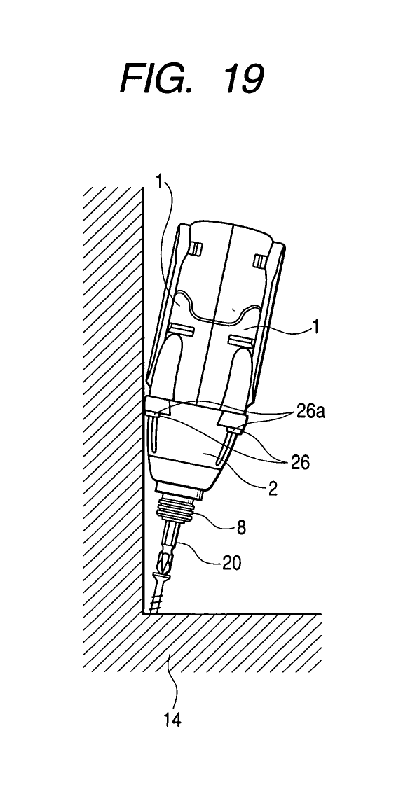

Next, the cover 25 which is made of a resin, and which is detachably attached to the outer periphery of the hammer case 2 housing the percussion mechanism 7 of the electric power tool will be described with reference to FIGS. 5 to 10. FIG. 5 is an external perspective view of the cover 25. As shown in FIG. 1, the cover is used with being attached to the outer periphery of the hammer case 2 made of metal such as aluminum or magnesium. The hammer case 2 is integrally fastened and fixed to the housing 1 with using a plurality of fastening screws 26. The heads 26a of the fastening screws 26 are exposed to the appearance of the electric power tool. In the case where the work shown in FIG. 15 is conducted in the state where the heads are exposed as described above, the fastening screws 26 are in contact with the work member 14, thereby causing a problem in that the work member 14 is damaged.

In the embodiment, therefore, the heads 26a of the fastening screws 26 are covered as shown in FIG. 1 by the cover 25 made of an elastic material (resin or rubber) which is lower in hardness than the material (metal) of the fastening screws 26, or which is softer, thereby preventing the heads 26a of the fastening screws 26 from being exposed. The cover 25 is surely positioned by the stopper (resin or elastic rubber) serving as a fixing unit shown in FIGS. 6 and 7 so that the cover 25 is not separated from the hammer case 2 toward the tool bit by impulsive vibration generated during the use of the electric power tool. As shown in FIG. 8, the attachment state by means of the cover 25 and the stopper 27 can be surely conducted by engaging fitting projections 2a formed on the hammer case 2 with fitting recesses 27a shown in FIGS. 6 and 7 and formed inside the stopper. According to the configuration, the cover 25 is in contact with the work member 14 as shown in FIGS. 9 and 10, and hence it is possible to solve the above-discussed problem. The fitting projections 2a and the fitting recesses 27a may be formed in a reversed manner.

An inclination (taper) 25b is formed in a front end portion of each of plural protrusions 25a which are disposed along the longitudinal direction of the cover 25 in order to respectively house the fastening screws 26. Even when an external member is in contact with one of the protrusions 25a, therefore, a shock can be moderated along the inclination 25b, i.e., it is possible to allow the member to escape along the inclination 25b. Therefore, the ease of use is improved, and the cover 25 can be prevented as far as possible from receiving damage, etc. Depending on the kind of a work, the user sometimes conducts the work while gripping the outer periphery of the hammer case 2. In such a case, when the hammer case 2 is heated by the heat which is generated during a process of striking the anvil claws 12a by the hammer claws 11a, it is difficult to grip the hammer case 2, whereby the workability and the operability are lowered. In the embodiment, since the cover 25 is disposed on the outer periphery of the hammer case 2, the influence of heat on the work can be reduced, so that an electric power tool having excellent ease of use can be provided.

The case where the hammer case 2 made of aluminum or magnesium is gripped, and that where the cover 25 in the embodiment is gripped will be compared with each other. In the case where the hammer case 2 is gripped, slippage occurs more easily from the view point of a frictional force, and, particularly when the hands of the user are wet with perspiration or water, slippage easily occurs. Consequently, a disadvantage that a work cannot be stably conducted is caused. By contrast, in the case where the cover 25 is gripped, slippage occurs more hardly than the case where the hammer case 2 made of aluminum or magnesium is gripped, and hence a work can be stably conducted.

In an electric power tool in which the cover 25 is not provided or the hammer case 2 is exposed, coating is applied in order to improve the appearance of the hammer case 2. In the embodiment, since the hammer case 2 is not exposed as a result of the disposition of the cover 25 on the outer periphery of the hammer case 2, it is not necessary to consider the appearance of the hammer case 2, and hence the cost and labor required for coating can be eliminated, with the result that an economical electric power tool can be provided.

As modifications of the cover 25, the cover may have the shapes of the covers 25′ and 25″ shown in FIGS. 11 and 12. The cover 25′ has a shape in which a rear portion (the portion on the side opposite to the tool bit) of the cover 25 is cut away, and which covers the outer peripheries of the fastening screws. The cover 25″ has a shape in which a front portion (the portion on the side of the tool bit) of the cover 25 is cut away, and which similarly covers the outer peripheries of the fastening screws. As described above, the shape of the cover 25 is not restricted to that of the embodiment and may have any shape as far as it can cover the outer peripheries of the heads 26a of the fastening screws 26.

According to the invention, a cover which covers outer peripheries of fastening screws is disposed on an outer periphery of a hammer case, whereby an electric power tool which can prevent a work member from being damaged, which is excellent in workability and operability, and which is economical can be provided.

What is claimed:

1. An electric power tool comprising:
a motor that serves as a driving source;
a percussion mechanism that includes:
a hammer that is driven by the motor; and
a anvil that rotates when hammered by the hammer;
a housing that houses the motor;
a hammer case that is disposed adjacent to the housing and that houses the percussion mechanism;
a cover that is disposed to cover an outer surface of the hammer case and that is formed of resin; and
a stopper that is disposed to cover the outer surface of the hammer case to prevent the cover from being separated from the hammer case,
wherein the hammer case includes a fitting projection that is formed on the outer surface of the hammer case, and
wherein the stopper includes a fitting recess that is formed on an inner surface of the stopper to fit with the fitting projection.

2. The power tool according to claim 1, wherein the fitting projection is formed on the outer surface of the hammer case along a circumferential direction of the anvil.

3. An electric power tool comprising:
a motor that serves as a driving source;
a percussion mechanism that includes:
a hammer that is driven by the motor; and
a anvil that rotates when hammered by the hammer;
a housing that houses the motor;
a hammer case that is disposed adjacent to the housing and that houses the percussion mechanism;
a cover that is disposed to cover an outer surface of the hammer case and that is formed of resin; and
a stopper that is disposed to cover the outer surface of the hammer case at a side opposite to the housing,
wherein one of the hammer case and the stopper includes a fitting portion and the other of the hammer case and the stopper includes a fitted portion that is formed to fit with the fitting portion.

4. The power tool according to claim 1, wherein the stopper is disposed around the anvil.

5. The power tool according to claim 4, wherein the stopper is disposed around the anvil.
